(19) United States
(12) Patent Application Publication
(10) Pub. No.: US 2018/0283511 A1
(43) Pub. Date: Oct. 4, 2018

(54) BALL SCREW DEVICE

(71) Applicant: JTEKT CORPORATION, Osaka (JP)

(72) Inventor: Akiyoshi TASHIRO, Yamatotakada-shi (JP)

(73) Assignee: JTEKT CORPORATION, Osaka (JP)

(21) Appl. No.: 15/928,709

(22) Filed: Mar. 22, 2018

(30) Foreign Application Priority Data
Mar. 29, 2017 (JP) 2017-065808

(51) Int. Cl. F16H 25/22; F16H 25/20; F16D 65/18; F16H 57/04

(52) U.S. Cl. CPC F16H 25/2238; F16H 25/2015; F16D 65/18; B60T 1/062; F16H 57/0497; F16H 2025/2031; F16H 57/0464

(57) ABSTRACT

A ball screw device includes a screw shaft, a nut, and a housing that has a bottomed cylindrical shape and to which the nut is attached. The ball screw device converts rotational motion of the screw shaft into linear motion of the housing. The ball screw device is switched between a normal use state and a supply state. In the normal use state, along with the linear motion, a bottom portion of the housing reciprocates between a first position spaced apart from an end of the screw shaft and a second position closer to the end. In the supply state, along with the linear motion, the bottom portion of the housing is located in a third position even closer to the end of the screw shaft, such that grease present in the nut and the bottom portion of the housing is introduced to a radially inner side of the nut.

### INCORPORATION BY REFERENCE

The disclosure of Japanese Patent Application No. 2017-065808 filed on Mar. 29, 2017 including the specification, drawings and abstract, is incorporated herein by reference in its entirety.

### BACKGROUND OF THE INVENTION

### 1. Field of the Invention

The invention relates to a ball screw device.

### 2. Description of Related Art

Ball screw devices can convert rotational motion into linear motion, and are widely used in various fields (see, for example, Japanese Patent Application Publication No. 2016-35322 (JP 2016-35322 A)). FIG. 6 is a cross-sectional view illustrating a ball screw device included in a braking device for an automobile. The ball screw device includes a screw shaft 91, a nut 92, a plurality of balls 93, and a housing 94. The nut 92 is disposed on the outer periphery of the screw shaft 91. The balls 93 are disposed between a helical groove of the screw shaft 91 and a helical groove of the nut 92. The nut 92 is attached to the housing 94. The housing 94 has a bottomed cylindrical shape, and the nut 92 is attached on an open side (right side in FIG. 6) of the housing 94. The housing 94 and the nut 92 are integrated into one unit. In a cylindrical portion (cylinder) 98 of the braking device, the housing 94 is movable in the axial direction, but is not rotatable in the circumferential direction. When the screw shaft 91 is rotated by a motor (not illustrated), the nut 92 and the housing 94 advance (or retract). In the case of the braking device, a pad 96 is attached to the housing 94 via a backup plate 95. When the housing 94 advances, the pad 96 comes into contact with a disk 100 that rotates with wheels of the automobile, thereby generating a braking force.

When the motor rotates normally, the nut 92 and the housing 94 advance to a first axial side. When the motor rotates reversely, the nut 92 and the housing 94 retract to a second axial side. In the case of the braking device, the housing 94 advances and retracts to perform reciprocating motion (stroke motion). When the housing 94 advances, the braking state is established (brake-on). When the housing 94 retracts, the braking is released (brake-off). As the reciprocating motion is repeated, grease on a raceway 99 that is provided between the nut 92 and the screw shaft 91 and in which the balls 93 are present is gradually pushed out to the axially outer side of the nut 92 where the balls 93 are not present, as indicated by the arrows G in FIG. 6. Then, the amount of the grease on the raceway 99 decreases, so that the lubricating performance decreases. Poor lubrication leads to a shorter service life of the ball screw device.

### SUMMARY OF THE INVENTION

An object of the present invention is to provide a ball screw device in which grease can be supplied between a nut and a screw shaft even when the amount of grease therebetween decreases.

A ball screw device according to an aspect of the present invention includes: a screw shaft having an outer periphery in which a first helical groove is formed; a nut disposed on the outer periphery of the screw shaft and having an inner periphery in which a second helical groove is formed; a plurality of balls disposed between the first helical groove and the second helical groove; and a housing that has a bottomed cylindrical shape and accommodates a first-axial-side end of the screw shaft on a bottom portion side corresponding to a first axial side, and to which the nut is attached on an open side corresponding to a second axial side; wherein rotational motion of one of the housing or the screw shaft is converted into linear motion of another of the housing and the screw shaft; and wherein the ball screw device is switched between a normal use state and a supply state, the normal use state being a state in which, along with the linear motion, a bottom portion of the housing reciprocates between a first position that is spaced apart from the end of the screw shaft and a second position that is closer to the end of the screw shaft than the first position, the supply state being a state in which, along with the linear motion, the bottom portion of the housing is located in a third position that is closer to the end of the screw shaft than the second position, such that grease present in the nut and the bottom portion of the housing is introduced to a radially inner side of the nut.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a cross-sectional view illustrating an example of a braking device;

FIG. 2 is an exploded perspective view illustrating a ball screw device;

FIG. 3 is a cross-sectional view illustrating the ball screw device;

FIGS. 4A, 4B, and 4C are cross-sectional views for explaining the operation of the ball screw device;

FIGS. 5A, 5B, and 5C are explanatory diagrams each illustrating a first helical groove and a second helical groove developed on a plane; and

FIG. 6 is a cross-sectional view illustrating a related-art ball screw device included in a braking device for an automobile.

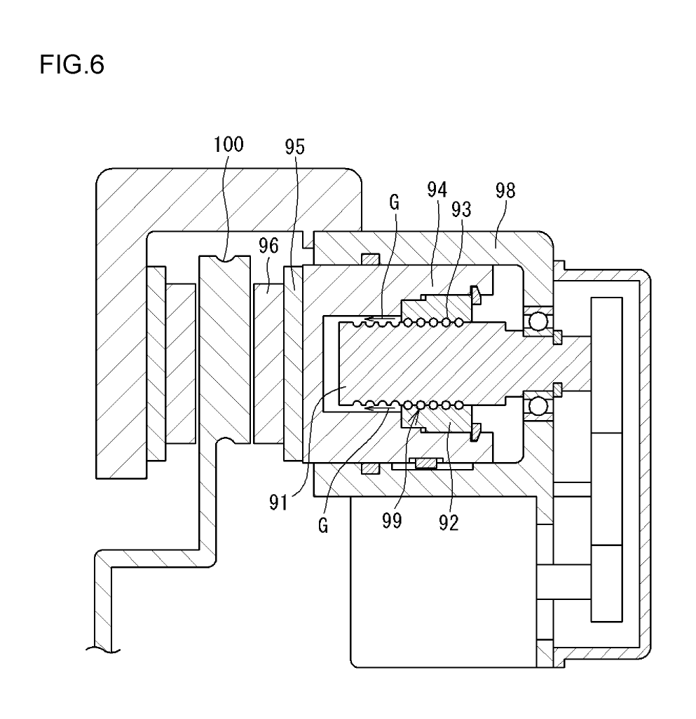

### DETAILED DESCRIPTION OF EMBODIMENTS

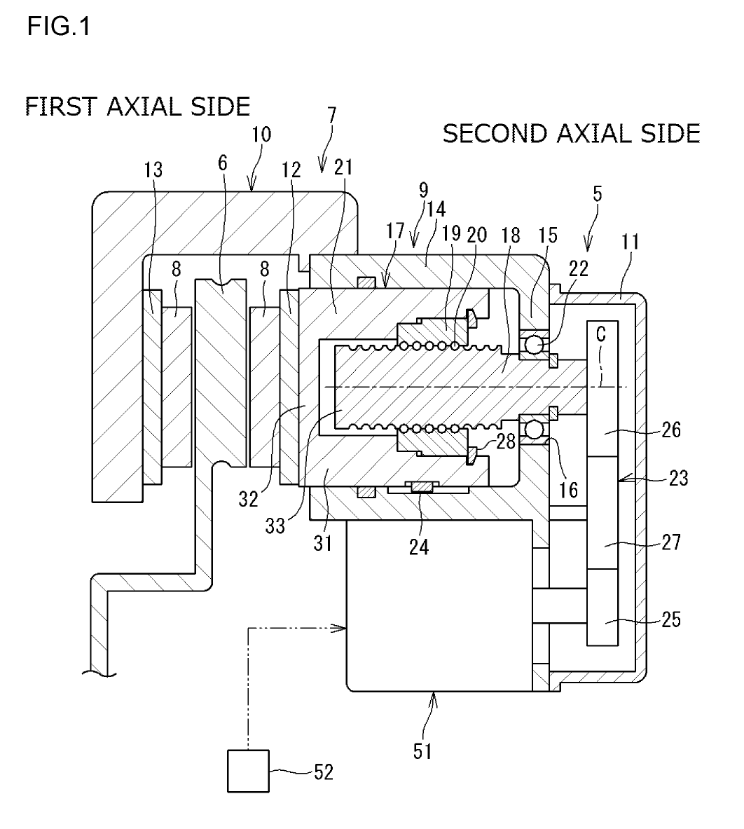

A ball screw device according to the present invention is used for, for example, a braking device for a vehicle (automobile). FIG. 1 is a cross-sectional view illustrating an example of a braking device 5. The braking device 5 applies a braking force generated by friction to a disk 6 that rotates with the wheels of the automobile. To generate the braking force, the braking device 5 includes a ball screw device 17. In FIG. 1, the braking device 5 is in a non-braking state.

The braking device 5 includes a floating type caliper 7, and paired pads 8. The caliper 7 is supported by a knuckle (not illustrated) or the like. The paired pads 8 hold the disk 6 therebetween. The caliper 7 includes a first body 9, a second body 10, and a cover 11. The second body 10 is integral with the first body 9. The cover 11 is attached to the first body 9. One of the pads 8 (on the right side in FIG. 1) is supported by a first backup plate 12 attached to a housing 21 (described below) of the ball screw device 17. The other one of the pads 8 (on the left side in FIG. 1) is supported by a second backup plate 13 attached to the second body 10.

The first body 9 has a cylindrical shape (bottomed cylindrical shape) including a cylindrical body portion 14 and a bottom plate portion 15, and is open toward the disk 6. The ball screw device 17 is disposed on the inner side of the cylindrical body portion 14. The ball screw device 17 includes a screw shaft 18, a nut 19, a plurality of balls 20, and the housing 21. An axis C of the screw shaft 18 coincides with the axis of the ball screw device 17. The direction parallel to the axis C is referred to as an axial direction.

A through hole 16 is formed in the bottom plate portion 15 of the first body 9. A rolling bearing 22 is attached to the through hole 16. The screw shaft 18 is supported by the first body 9 via the rolling bearing 22 to be rotatable in the circumferential direction about the axis C but not to be movable in the axial direction. A key 24 is disposed between the housing 21 and the cylindrical body portion 14. The housing 21 is reciprocally movable with respect to the cylindrical body portion 14 in the axial direction, but is not rotatable in the circumferential direction about the axis C.

The nut 19 and the housing 21 are integrated into one unit as will be described below. When the screw shaft 18 rotates in one direction (rotates normally), the nut 19 and the housing 21 move to the first axial side (left side in FIG. 1) along the screw shaft 18. On the other hand, when the screw shaft 18 rotates in the other direction (rotates reversely), the nut 19 and the housing 21 move to the second axial side (right side in FIG. 1) along the screw shaft 18. In the braking device 5 of FIG. 1, the moving housing 21 serves as a piston. The first body 9 (cylindrical body portion 14) serves as a cylinder that accommodates and guides the housing 21.

A motor (electric motor) 51 and a speed reducer 23 are provided on the outer side of the cylindrical body portion 14. A command signal is input from a control unit 52 to the motor 51, and the motor 51 rotates normally, rotates reversely, or stops, in accordance with the command signal. The speed reducer 23 includes a first gear 25, a second gear 26, and an intermediate gear 27. The first gear 25 is fixed to an output shaft of the motor 51. The second gear 26 is fixed to a second-axial-side end of the screw shaft 18. The intermediate gear 27 is disposed between the gears 25 and 26. Note that the speed reducer 23 may have a different configuration.

With the configuration described above, when the motor 51 rotates, the nut 19 and the housing 21 move in the axial direction. That is, rotational motion of the screw shaft 18 transmitted from the motor 51 via the speed reducer 23 is converted into linear motion of the housing 21 in the axial direction, by the ball screw device 17. Thus, the paired pads 8 hold the disk 6 to generate a braking force.

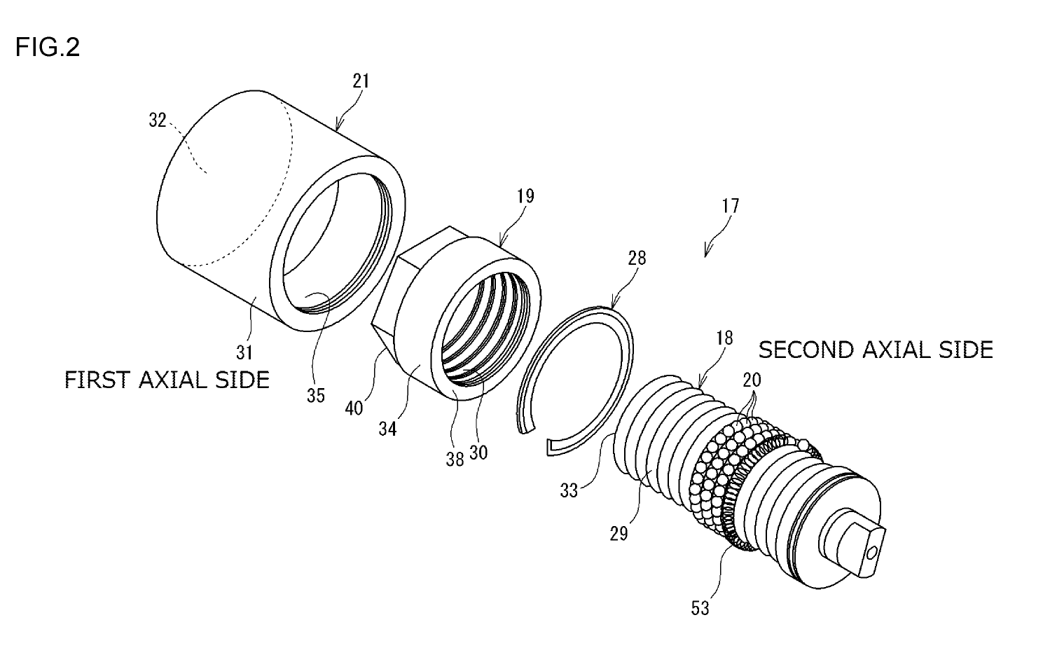

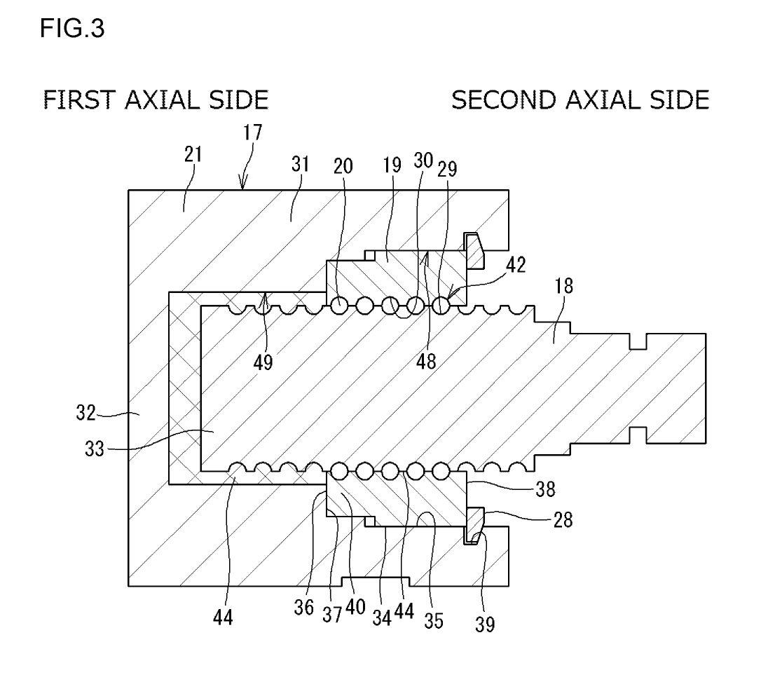

FIG. 2 is an exploded perspective view illustrating the ball screw device 17. FIG. 3 is a cross-sectional view illustrating the ball screw device 17. As illustrated in FIGS. 2 and 3, the ball screw device 17 includes the screw shaft 18 as an input member, and the nut 19 as an output member disposed on the outer periphery of the screw shaft 18. A first helical groove 29 is formed in the outer periphery of the screw shaft 18, and a second helical groove 30 is formed in the inner periphery of the nut 19. The screw shaft 18 is longer than the nut 19 in the axial direction, and the first helical groove 29 is formed across a range greater than the nut 19 (second helical groove 30) in the axial direction. The plurality of balls 20 are disposed between the first helical groove 29 and the second helical groove 30. In the present embodiment, as will be described below, coil springs 53 are disposed between the first helical groove 29 and the second helical groove 30.

The housing 21 has a bottomed cylindrical shape including a cylindrical portion 31 and a bottom portion 32. The housing 21 can accommodate a first-axial-side end 33 of the screw shaft 18 on the bottom portion 32 side, that is, the first axial side. Further, the nut 19 is attached to the housing 21 on the open side, that is, the second axial side. To attach (fix) the nut 19 to the housing 21, the ball screw device 17 includes a C-shaped snap ring 28 that is in contact with a second-axial-side end face 38 of the nut 19.

In FIG. 3, the cylindrical portion 31 of the housing 21 includes an inner peripheral surface 35, an annular surface 37, and a recessed groove 39. An outer peripheral surface 34 of the nut 19 fits to the inner peripheral surface 35. The annular surface 37 is in contact with a first-axial-side end face 36 of the nut 19. The snap ring 28 is attached to the recessed groove 39. The nut 19 is fitted to the inner peripheral surface 35 of the housing 21, and the snap ring 28 is attached to the recessed groove 39. Thus, the nut 19 is held between the annular surface 37 of the housing 21 and the snap ring 28. Accordingly, the nut 19 is prevented from coming off from the second axial side of the housing 21. The space defined on the inner peripheral side of the housing 21 includes a hole portion 49 with a smaller diameter and a hole portion 48 with a larger diameter. The hole portion 49 is located on the first axial side with respect to (the inner peripheral edge) of the annular surface 37. The hole portion 48 includes the annular surface 37, and is located on the second axial side (open side) with respect to the annular surface 37. The nut 19 is attached to the hole portion 48 with the larger diameter.

As illustrated in FIG. 2, a first-axial-side end 40 of the nut 19 has a polygonal outer peripheral shape. A first axial side of the inner peripheral surface 35 of the housing 21 has a polygonal shape corresponding to the shape of the end 40 of the nut 19. Thus, the nut 19 and the housing 21 are integrated into one unit. Further, the nut 19 and the housing 21 are not relatively rotatable.

The ball screw device 17 (see FIG. 3) of the present embodiment is of a non-circulation type in which the balls 20 do not circulate. The plurality of balls 20 and the coil springs 53 (see FIG. 2) are disposed on a raceway 42 between the first helical groove 29 and the second helical groove 30.

The ball screw device 17 with the configuration described above uses a grease lubrication system. Grease is applied to the raceway 42 in which the plurality of balls 20 are disposed. The grease is applied when the ball screw device 17 is assembled. In the present embodiment (see FIG. 3), grease 44 is applied to the raceway 42, and is also provided in the space between the screw shaft 18 and the housing 21 (hole portion 49 with the smaller diameter). The space between the screw shaft 18 and the housing 21 is filled with the grease 44.

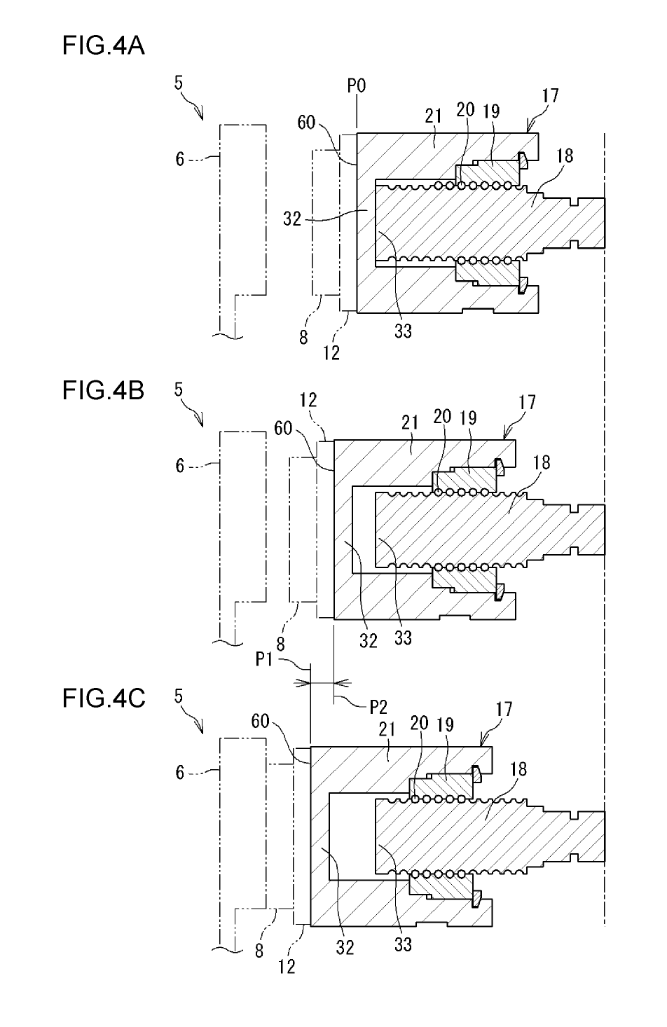

FIGS. 4A, 4B, and 4C are cross-sectional views for explaining the operation of the ball screw device 17. As described above, when the screw shaft 18 rotates in one direction (rotates normally), the housing 21 and the nut 19 linearly move to the first axial side, that is, to the side toward the disk 6 of the braking device 5. When the screw shaft 18 rotates in the other direction (rotates reversely), the housing 21 and the nut 19 linearly move to the second axial side, that is, to the side away from the disk 6. As described above, the control unit 52 controls switching between normal rotation and reverse rotation of the screw shaft 18.

The movement of the housing 21 (and the nut 19) in the direction toward the disk 6 is referred to as “advancement”. The movement of the housing 21 (and the nut 19) in the direction away from the disk 6 is referred to as “retraction”. FIGS. 4A, 4B, and 4C illustrate displacement of the housing 21 (and the nut 19) in the axial direction, with respect to the screw shaft 18 that is not displaced. In FIG. 4A, the housing 21 is in its retracted (most retracted) position, and the bottom portion 32 thereof is in its close (closest) position to the end 33 of the screw shaft 18. The position of the bottom portion 32 (end face 60) of the housing 21 in this state is defined as an “origin position P0”. In FIG. 4B, the housing 21 is advanced from the origin position P0. In FIG. 4C, the housing 21 is further advanced from the position illustrated in FIG. 4B. The position of the bottom portion 32 (end face 60) of the housing 21 illustrated in FIG. 4C is defined as a “first position P1”. The position of the bottom portion 32 (end face 60) of the housing 21 illustrated in FIG. 4B is defined as a “second position P2”. The bottom portion 32 of the housing 21 located in the first position P1 of FIG. 4C is spaced apart from the end 33 of the screw shaft 18 in the axial direction. The bottom portion 32 of the housing 21 located in the second position P2 of FIG. 4B is closer to the end 33 of the screw shaft 18 in the axial direction than the first position P1.

As illustrated in FIG. 4B, when the bottom portion 32 of the housing 21 is in the second position P2, the pad 8 is not in contact with the disk 6, and a non-braking state is established. On the other hand, as illustrated in FIG. 4C, when the bottom portion 32 of the housing 21 is in the first position P1, the pad 8 is in contact with the disk 6, and a braking state is established. If the driver of the automobile brakes hard (brakes suddenly), the housing 21 can move toward the first axial side (left side in FIGS. 4A, 4B, and 4C) beyond the first position P1. However, the following describes the operations of the braking device 5 and the ball screw device 17 in a normal use state where the brake is operated to reduce the speed during normal travel, and does not describe the operations in an emergency operation state where the driver brakes suddenly as described above. In the normal use state, every time the driver operates the brake, the motor 51 operates in response to a signal from the control unit 52. Then, as the housing 21 linearly moves along with rotational motion of the screw shaft 18, the bottom portion 32 (end face 60) of the housing 21 reciprocates between the first position P1 of FIG. 4C and the second position P2 of FIG. 4B.

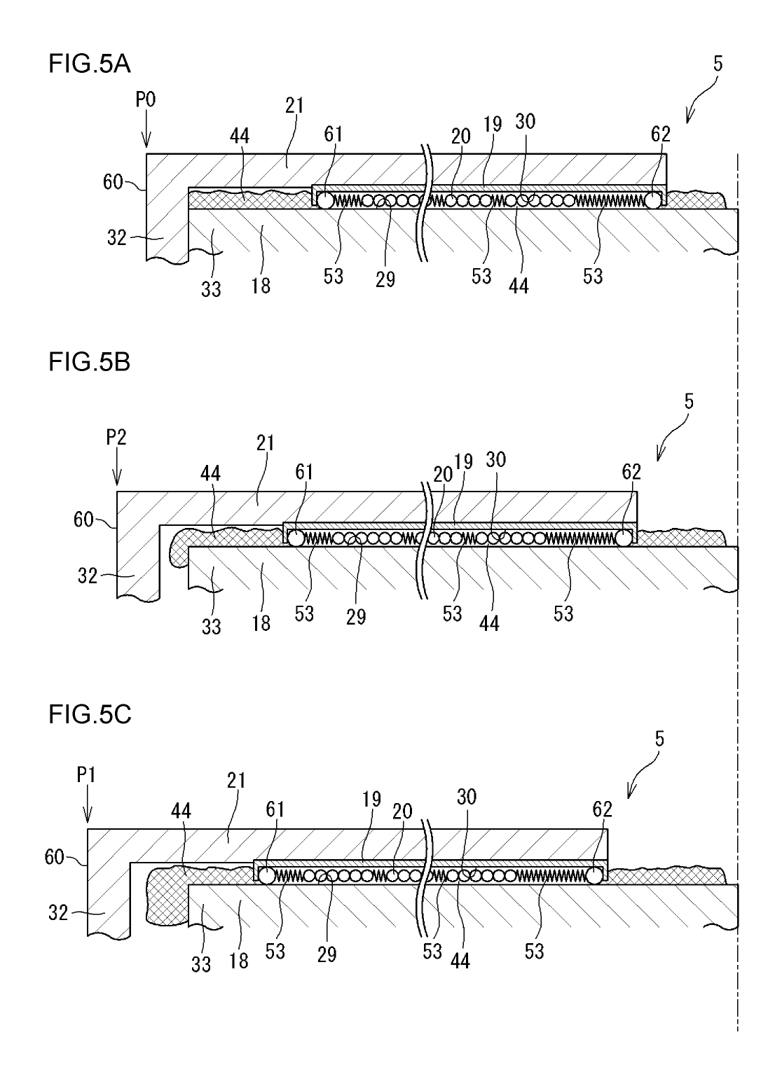

FIGS. 5A, 5B, and 5C are explanatory diagrams each illustrating the first helical groove 29 of the screw shaft 18 and the second helical groove 30 of the nut 19 developed on a plane. FIGS. 5A, 5B, and 5C schematically illustrate the nut 19 and the housing 21 that is integral with the nut 19. All the balls 20 are accommodated on the inner peripheral side of the nut 19. Stopper members 61 and 62 are provided at opposite ends of the second helical groove 30 to prevent the balls 20 from falling out of the second helical groove 30. One of the coil springs 53 is disposed between the stopper member 61 and the row of the plurality of balls 20. Another of the coil springs 53 is disposed between the other stopper member 62 and the row of the plurality of balls 20. In the present embodiment, still another of the coil springs 53 is disposed in the row of the plurality of balls 20.

The grease 44 is applied to the second helical groove 30 of the nut 19 in which the balls 20, the stopper members 61 and 62, and the coil springs 53 are disposed, and the first helical groove 29 facing the second helical groove 30. However, in the normal use state described above, the bottom portion 32 (end face 60) of the housing 21 reciprocates between the first position P1 of FIG. 5C and the second position P2 of FIG. 5B, and this reciprocating motion is continuously repeated. Therefore, the grease 44 is gradually pushed out to the axially outer side of the nut 19 (see FIG. 5C).

In view of this, in the ball screw device 17 of the present embodiment, as the housing 21 linearly moves (retracts) along with rotational motion of the screw shaft 18, the bottom portion 32 of the housing 21 is located in a third position that is closer to the end 33 of the screw shaft 18 than the second position P2 of FIG. 5B, at a predetermined timing. In the present embodiment, the origin position P0 (FIG. 5A) is the third position. That is, the bottom portion 32 of the housing 21 retracts to the origin position P0 of FIG. 5A at a predetermined timing, after reciprocating between the first position P1 of FIG. 5C and the second position P2 in FIG. 5B.

When the bottom portion 32 of the housing 21 is located in the origin position P0 (third position), the bottom portion 32 is close to the end 33 of the screw shaft 18. Thus, the grease 44 that is pushed out by the reciprocating motion described above and is present between the nut 19 and the bottom portion 32 of the housing 21 is pushed by the bottom portion 32 to flow toward the nut 19, and is introduced to the radially inner side of the nut 19. The state of FIG. 5A where the bottom portion 32 of the housing 21 is in the origin position P0 (the third position) is referred to as a “supply state”.

With the configuration described above, in the braking device 5 of the present embodiment, other than the normal use state in which the brake is operated during normal travel, the supply state is established, although at a lower frequency than the normal use state. Switching between the normal use state and the supply state is performed in accordance with a command signal transmitted from the control unit 52 to the motor 51. That is, the control unit 52 outputs different signals for switching the state to the motor 51.

The normal use state is switched to the supply state when, for example, a parking brake that is used for parking the automobile is applied. That is, when a service brake that is used during travel of the automobile (vehicle) is applied, the braking device 5 (ball screw device 17) is in the normal use state. However, when the parking brake that is used for parking the automobile is applied, the braking device 5 is placed in the supply state (FIGS. 4A and 5A). Then, immediately after the braking device 5 (ball screw device 17) is placed in the supply state, the screw shaft 18 rotates in the reverse direction, so that the housing 21 is placed in a first state illustrated in FIGS. 4C and 5C. Thus, the braking state is established by the parking brake. Note that since the parking brake is used when, for example, refueling the automobile or when parking the automobile in a parking lot, the braking device 5 (ball screw device 17) is placed in the supply state every time the automobile travels a certain amount of distance. Alternatively, the control unit 52 may perform a control operation to switch the ball screw device 17 to the supply state every time the automobile travels a predetermined distance (e.g., 500 kilometers) (regardless of whether the parking brake is used).

As described above, the ball screw device 17 of the present embodiment is used while being switched between the normal use state and the supply state. In the normal use state, along with linear motion of the housing 21, the bottom portion 32 thereof reciprocates between the first position P1 (FIGS. 4C and 5C) spaced apart from the end 33 of the screw shaft 18 and the second position P2 (FIGS. 4B and 5B) that is closer to the end 33 of the screw shaft 18 than the first position P1. On the other hand, in the supply state, along with linear motion of the housing 21, the bottom portion 32 thereof is located in the third position (origin position P0: FIGS. 4A and 5A) that is closer to the end 33 of the screw shaft 18 than the second position P2. Thus, the grease 44 present between the nut 19 and the bottom portion 32 of the housing 21 is introduced to the radially inner side of the nut 19.

According to the ball screw device 17, in the normal use state, the bottom portion 32 of the housing 21 continuously reciprocates between the first position P1 and the second position P2. Therefore, the amount of the grease 44 between the nut 19 and the screw shaft 18 may decrease. In view of this, in the supply state, the grease 44 present between the nut 19 and the bottom portion 32 of the housing 21 is pushed by the bottom portion 32 of the housing 21 to flow, and is introduced to the radially inner side of the nut 19. In this manner, even when the amount of the grease 44 between the nut 19 and the screw shaft 18 decreases in the normal use state, the grease 44 is supplied to restore the lubricating performance by switching to the supply state. This leads to a longer service life of the ball screw device 17.

The ball screw device 17 of the present embodiment is for the braking device 5 for an automobile, and is placed in the supply state when the parking brake is applied. Therefore, the grease 44 is supplied when, for example, the automobile is parked, so that the lubricating performance is restored. Since the ball screw device 17 is placed in the supply state when the parking brake is applied, the ball screw device 17 is less frequently placed in the supply state than in the normal use state. Therefore, operations of the brake (service brake) during travel of the automobile are not disturbed, allowing the braking device 5 to be operated mainly in the normal use state during travel.

The presently disclosed embodiment should be considered in all respects to be illustrative and not restrictive. Accordingly, the ball screw device of the present invention is not limited to the illustrated embodiment, and modifications and other embodiments are intended to be included within the scope of the invention. In the above embodiment, the third position is the origin position P0. However, the third position may be a position other than the origin position P0, and may be a position between the second position P2 and the origin position P0. The third position does not have to be a constant position, and may vary in accordance with the settings. In the above embodiment, the ball screw device 17 converts rotational motion of the screw shaft 18 into linear motion of the housing 21. However, unlike this ball screw device 17, a ball screw device 17 that converts rotational motion of the housing 21 (and the nut 19) into linear motion of the screw shaft 18 may also include the elements described above. That is, the ball screw device of the present invention may be any ball screw device that converts rotational motion of one of a housing and a screw shaft into linear motion of the other one of the housing and the screw shaft.

Although the ball screw device 17 of the above embodiment is of a non-circulation type in which the balls 20 do not circulate, the ball screw device 17 may be of a circulation type. Further, in the above description, the ball screw device 17 is used for a braking device. However, the ball screw device 17 is applicable to other devices as well.

According to the present invention, even when the amount of grease between a nut and a screw shaft decreases, grease is supplied to restore the lubricating performance by switching to a supply state, so that the service life of the ball screw device can be extended.

What is claimed is:

1. A ball screw device comprising:
a screw shaft having an outer periphery in which a first helical groove is formed;
a nut disposed on the outer periphery of the screw shaft and having an inner periphery in which a second helical groove is formed;
a plurality of balls disposed between the first helical groove and the second helical groove; and
a housing that has a bottomed cylindrical shape and accommodates a first-axial-side end of the screw shaft on a bottom portion side corresponding to a first axial side, and to which the nut is attached on an open side corresponding to a second axial side;
wherein rotational motion of one of the housing or the screw shaft is converted into linear motion of another of the housing and the screw shaft; and
wherein the ball screw device is switched between a normal use state and a supply state,
the normal use state being a state in which, along with the linear motion, a bottom portion of the housing reciprocates between a first position that is spaced apart from the end of the screw shaft and a second position that is closer to the end of the screw shaft than the first position,
the supply state being a state in which, along with the linear motion, the bottom portion of the housing is located in a third position that is closer to the end of the screw shaft than the second position, such that grease present in the nut and the bottom portion of the housing is introduced to a radially inner side of the nut.

2. The ball screw device according to claim 1, wherein the supply state is less frequently established than the normal use state.

3. The ball screw device according to claim 1,
wherein the ball screw device is for a braking device for a vehicle; and
wherein the normal use state is established when the vehicle travels, and the supply state is established when the vehicle is parked.

4. The ball screw device according to claim 2,
wherein the ball screw device is for a braking device for a vehicle; and
wherein the normal use state is established when the vehicle travels, and the supply state is established when the vehicle is parked.
